(19) United States
(12) Patent Application Publication
(10) Pub. No.: US 2018/0264870 A1
(43) Pub. Date: Sep. 20, 2018

(54) Pocket Folder with Reinforced Pocket

(71) Applicants: Marvin A. Makofsky, Sands Point, NY (US); Robert Makofsky, New York, NY (US); Sari Makofsky McConnell, Burlingame, CA (US)

(72) Inventors: Marvin A. Makofsky, Sands Point, NY (US); Robert Makofsky, New York, NY (US); Sari Makofsky McConnell, Burlingame, CA (US)

(21) Appl. No.: 15/192,204

(22) Filed: Jun. 24, 2016

(51) Int. Cl. B42F 7/06; B65D 27/08

(52) U.S. Cl. CPC B42F 7/06; B65D 27/08

(57) ABSTRACT

The blank for making a folder is formed with a rhombic-shaped tab on each side flap. When each flap is folded over or under an extension folded onto the main section of the blank, the rhombic-shaped tab reinforces the corner of the pocket formed by folding over each flap onto a folded up extension.

This invention relates to a pocket folder with a reinforced pocket and to a blank for making the pocket folder.

As is known, various types of pocket folders have been constructed for the holding of sheets of paper and the like.

For example, U.S. Pat. No. 8,684,259 describes a pocket folder with a reinforced corner formed by incorporating a rhombic shaped tab in an extension that folds over a main rectangular section.

It is an object of the invention to improve the construction of a folder with a reinforced pocket.

It is another object of the invention to provide a simple blank for making an expandable pocket folder using a limited size of paper.

Briefly, the invention provides a one-piece blank for making a pocket folder as well as an expandable pocket folder made from the blank.

The blank is made of conventional card stock or other paperboard or plastic product with at least a pair of contiguous rectangular sections for folding over on each other. In addition, an extension extends from a bottom edge of each section for folding over the section to form a pocket. Flaps are also provided to cooperate with the extensions to close in one side of each pocket.

In accordance with the invention, a rhombic-shaped tab extends outwardly of each flap to reinforce a corner of each open pocket.

These and other objects and advantages of the invention will become more apparent from the following detailed description taken in conjunction with the accompanying drawings wherein:

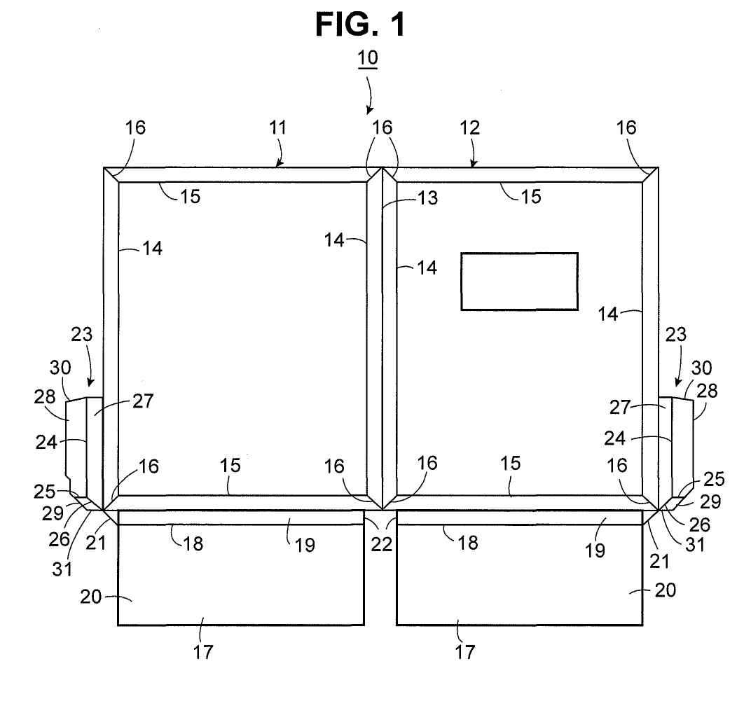

FIG. 1 illustrates a view of the front of a blank used to make a pocket folder in accordance with the invention; and

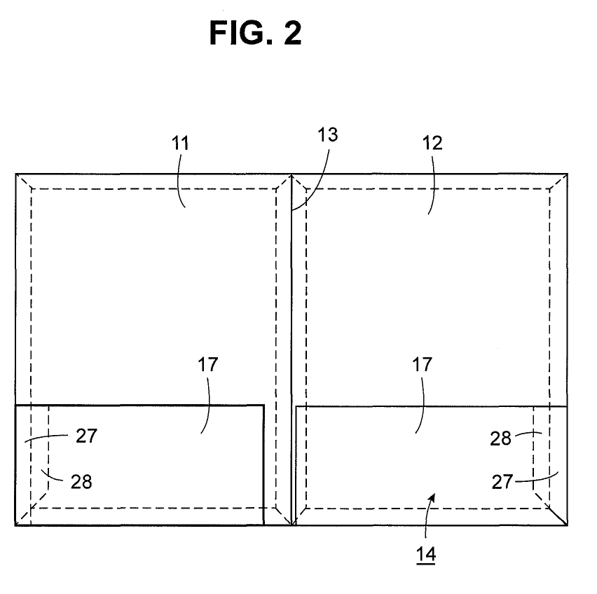

FIG. 2 illustrates a front view of a pocket folder made from the blank of FIG. 1 in an opened condition in accordance with the invention.

Referring to FIG. 1, the blank 10 is a flat sheet of conventional paper or other suitable material, such as described in published US Patent Application 2007/022811, divided into a pair of contiguous rectangular sections 11, 12 that are separated by a vertical fold line 13. Each rectangular section 11, 12 is of a conventional 9½ inch by 12 inch size.

Each rectangular section 11, 12 is provided with a set of vertical score lines 14, horizontal score lines 15 and angular score lines 16. As shown, each angular score line 16 extends from the intersection of a vertical score line 14 with a horizontal score line 15 to a corner of the respective section 11, 12.

Of note, the score lines 14, 15, 16 on the sections 11, 12 are optional. When present, the score lines contribute to aesthetics and flatness of folder when closed but do not impact pocket capacity in a meaningful way.

Each section 11, 12 has an extension 17 extending from a bottom edge for folding over the respective section 11, 12 to define a pocket as shown in FIG. 2.

Each extension 17 has a horizontally disposed score line 18 spaced from the bottom edge of the respective section 11, 12 to divide the extension 17 into a first section 19 adjacent a respective section 11, 12 and a rectangular section 20.

As illustrated, the first section 19 has an angled edge 21 at one end and an edge 22 perpendicular to the respective section 11, 12 at the opposite end. The first section 19 is of a height to overlie the area defined by a horizontal score line 15 and bottom edge of a respective section 11, 12. In addition, the angled edge 21 overlies a respective angular score line 16.

The second section 20 of each extension 17 is of a width equal to the distance between two vertical score lines 14 of a respective section 11, 12.

Each extension 17 is of a length, for example 4 inches, so that when folded over a respective section, 11, 12, the extension 17 covers a minor fraction of the height of the respective 12 inch high section 11, 12, i.e. ⅓ the height of the section 11, 12.

Each section 11, 12 also has a flap 23 extending from one side for folding under (or over) the extension 17 with the extension 17 folded over a respective section 11, 12.

This flap 23 has a vertically disposed score line 24 intermediately thereof, a horizontal score line 25 extending from the bottom of the vertical score line 24 to the outside edge of the flap 23 and an angular score line 26 extending from the intersection of the vertical score line 24 with the horizontal score line 25 to a bottom corner of the flap 23. The score lines 24, 25, 26 divide the flap 23 into a first part 27 contiguous to the respective section 11, 12, a second part 28 for folding flat against a respective extension 17 and a rhombic-shaped tab 29.

The horizontal score line 25 is co-linear with a horizontal score line 15 of a respective section 11, 12 so that when the flap 23 is folded over the respective section 11, 12, the horizontal score line 25 of the flap 23 overlies the horizontal score line 15 of the respective section 11, 12.

As illustrated, the rhombic-shaped tab 29 extends outwardly of the first part 27 and the second part 28 of the flap 23 to reinforce a corner of the pocket formed by the extension 17 and flap 23 when folded over a respective section 11, 12.

As illustrated, the first part 27 of the flap 23 is of a width to overlie the area defined by a vertical score line 14 and side edge of a respective section 11, 12. In addition, the angular score line 26 overlies a respective angular score line 16 when folded over the respective section 11, 12.

The first part 27 of the flap 23 is of equal height to the height of the respective extension 17.

The second part 28 of the flap 23 is of a generally rectangular shape with a slightly beveled edge 30 at the top and is of any suitable width to be secured to a respective extension 17.

The second part 28 of the flap 23 is secured by a suitable adhesive or glue to the rectangular section 20 of the extension 17 while the first part 27 is free to move relative to the respective section 11, 12.

The rhombic-shaped tab 29 of the flap 23 has a rectilinear lower edge 31 that is slightly spaced from the bottom edge of a respective section 11, 12 when the flap 23 is folded over the respective section 11, 12. The placement of the rhombic-shaped tab 29 is such as to form a three ply construction with the respective section 11, 12 and the extension 17 at the lower corner of the formed pocket.

Referring to FIG. 2, in order to form a pocket folder from the blank 10, a suitable adhesive or glue is applied to the underside of the second part 28 of each flap 23. Each flap 23 is then folded over a respective section 11, 12 followed by folding of each extension 17 over the flaps 23 in order to secure the extensions 17 to the flaps 23.

One advantage of placing the rhombic-shaped tab 29 on the flap 23 rather than on the extension is that the fabrication of the blank 10 is simplified and the rhombic-shaped tab 29 cannot pop out from under first section 19 of the extension 17.

1. A one piece blank for making a folder comprising
at least a pair of rectangular sections;
a first extension extending from a bottom edge of one of said sections for folding over said one section to define an open pocket, said extension having a horizontally disposed score line spaced from a bottom edge of said one section dividing said extension into a first section adjacent said one section and a rectangular section;
a first flap extending from a side edge of said one section and having a vertically disposed score line intermediately thereof to separate said first flap into a first part contiguous to said one section and a second part for folding flat against said extension;
a rhombic-shaped tab extending outwardly of said first part and said second part of said first flap.

2. A one piece blank as set forth in claim 1 wherein a second extension extends from a bottom edge of the other of said sections for folding over said other section to define an open pocket, a second flap extends from a side edge of said other section and has a vertically disposed score line intermediately thereof to separate said second flap into a first part contiguous to said other section and a second part for folding flat against said second extension and a rhombic-shaped tab extending outwardly of said first part and said second part of said second flap.

3. A folder comprising
at least a pair of rectangular sections;
a first extension extending from a bottom edge of one of said sections and folded over said one section to define an open pocket, said extension having a horizontally disposed score line spaced from a bottom edge of one section dividing said extension into a first section adjacent said one section and a rectangular section;
a first flap extending from a side edge of said one section and secured to said extension, said first flap having a vertically disposed score line intermediately thereof to separate said first flap into a first part contiguous to said one section and a second part folded flat against and secured to said first extension;
a rhombic-shaped tab extending outwardly of said first part and said second part of said first flap to reinforce a corner of said open pocket;
a second extension extending from a bottom edge of the other of said sections and folded over said other section to define a second open pocket, said second extension having a horizontally disposed score line dividing said second extension into a first section adjacent said other section and a rectangular section;
a second flap extending from a side edge of said other section and having a vertically disposed score line intermediately thereof to separate said second flap into a first part contiguous to said other section and a second part for folding flat against said second extension; and
a rhombic-shaped tab extending outwardly of said first part section and said second part of said second flap to reinforce a corner of said second open pocket.
